(19) United States
(12) Patent Application Publication
(10) Pub. No.: US 2025/0112786 A1
(43) Pub. Date: Apr. 3, 2025

(54) METHOD AND SYSTEM FOR GENERATING DIGITAL SIGNATURES USING UNIVERSAL COMPOSITION

(71) Applicant: LEVERCODE OU, Tallinn (EE)

(72) Inventors: Oskar Poola, Tallinn (EE); Märt Saarepera, Tallinn (EE); Gustav Poola, Tallinn (EE); Nils Grossberg, Tallinn (EE); Kristjan Ress, Tallinn (EE)

(21) Appl. No.: 18/725,455

(22) PCT Filed: Dec. 29, 2022
(86) PCT No.: PCT/EP2022/088030

§ 371 Date: Jun. 28, 2024

Related U.S. Application Data
(60) Provisional application No. 63/294,973, filed on Dec. 30, 2021.

(51) Int. Cl. H04L 9/32

(52) U.S. Cl. CPC H04L 9/3255

(57) ABSTRACT

A system and method to general cryptographically secure digital signatures using universal composition is disclosed herein. An example system includes a first secure device that generates a first private key according to a first cryptographic scheme, and in response to receiving document data, generates a first signature according to the first cryptographic scheme using the document data and the first private key. The example system also includes a second secure device that generates a second private key according to a second cryptographic scheme, generates a second signature according to the second cryptographic scheme using composite data and the second private key, generates a total signature based on the first signature, the second signature, and the supplemental data, and appends the total signature to a digital document from which the document data was derived.

### TECHNICAL FIELD

The present invention is generally related to digital signatures and, more specifically, cryptographically secure digital signatures using universal composition.

### BACKGROUND

Digital signatures are widely used by governments and companies in lieu of manual signatures as proof of identity and intent to be bound by the document being signed. These signatures use cryptographic schemes that try to ensure that only a unique person can generate a particular signature and allow a person inspecting the signature to verify that it was in fact initiated by that unique person. To verify that the unique person is the person who can cause the particular signature to be created, these schemes often use the cryptographic principle of using something someone has (e.g., biometric markers, security tokens (such as a physical security key, an chip-embedded identification card, etc.), etc.) and something someone knows (e.g., credentials, etc.). These cryptographic schemes often use asymmetric cryptography which relies on a secret private key and a non-secret public key associated with an individual. For example, a country or government may issue a chip-embedded identity card with an authentication key (e.g., a private key) used to log into governmental service websites by providing a signature and a signature key (e.g., another private key) used to give legally binding digital signatures. However, as technology advances, some cryptographic schemes become obsolete. For example, a weakness may be discovered in the computer implemented cryptographic scheme or the computational power of computers trying to break such a computer implemented cryptographic scheme may increase. Additionally, increasingly secure cryptographic schemes may be developed. As such, from time to time, the cryptographic scheme that a digital signature system uses may need to be updated. However, replacing security tokens, such as government issued chip-embedded identity cards, can be logistically difficult and expensive.

### SUMMARY

As described herein, a flexible technologically implemented cryptographic scheme is employed to identify and prove the intent of persons participating in electronic communication and commerce and attack tolerant implementation of public key digital signature mechanisms. A first secure device includes a key generation function that produces a private key and a public key. The public key is shared such that signatures generated by the private key can be tested for validity using the public key. The first secure device may be, for example, a chip-embedded identity card or other physical digital security token. Each first secure device is associated with a unique private and public key. A second secure device includes a second key generation function that produces a private key and a public key. The second secure device may be, for example, a central cryptography server or set of servers that manage the digital signature scheme. The second secure device is associated with a unique private and public key. In some examples, the second secure device may also maintain the database of the public keys associated with the first secure devices. The cryptographic scheme used by the key generation function and the signature generation function of the first secure device may be different than the cryptographic scheme used by key generation function and the signature generation function of the second secure device.

The digital signature system described herein generates a composite public key and composite signature (sometimes referred to as a “universal composite signature”). The first secure device receives document data to be used to generate a signature using its associated private key stored by the first secure device. This document data is generally related to a digital document to be signed. For example, the data may be all or a part of the digital document to be signed or a message digest computed from the digital document by applying a cryptographic hash function (e.g., SHA-256, etc.) to the digital document. As used herein, the digital document may be any set of digital information. The second secure device receives composite data to be used to generate a signature using its private key stored by the second secure device. The composite data is generated through a combinatory function (such as a hash function or series of hash functions) based on the document data used by the first secure device and additional data associated with the first secure device. A signature generation function generates a total signature based on the signatures generated by the first and second secure devices. This total signature is attached and/or otherwise associated with the digital document as an attestation that the digital document was signed by the unique person. When the composite signature is to be verified, a total public key generation function generates a total public key based on the public keys of the first and second secure devices. A verification function determines whether the composite signature is valid or invalid based on the composite public key and the document data derived from the digital document.

An example system includes a first secure device that generates a first private key according to a first cryptographic scheme, and in response to receiving document data, cryptographically generates a first signature according to the first cryptographic scheme using the document data and the first private key. The example system also includes a second secure device that cryptographically generates a second private key according to a second cryptographic scheme, in response to receiving the document data and the first signature, generates composite data with a deterministic function based on the document data and supplemental data comprising at least one parameter uniquely associated with the first secure device, cryptographically generates a second signature according to the second cryptographic scheme using the composite data and the second private key, generates a total signature based on the first signature, the second signature, and the supplemental data, and appends the total signature to a digital document from which the document data was derived.

An example system includes a first secure device, a second secure device, and a server. The first secure device generates a first private key according to a first cryptographic scheme, and in response to receiving document data, cryptographically generate a first signature according to the first cryptographic scheme using the document data and the first private key. The second secure device cryptographically generates a second private key according to a second cryptographic scheme, in response to receiving the document data and the first signature, generates composite data with a deterministic function based on the document data and supplemental data comprising at least one parameter uniquely associated with the first secure device, and cryptographically generates a second signature according to the second cryptographic scheme using the composite data and the second private key. The server generates a total signature based on the first signature, the second signature, and the supplemental data, and appends the total signature to a digital document from which the document data was derived.

A method to generate a signature for a digital document comprises (a) generating, by a first secure device, a first private key according to a first cryptographic scheme, (b) in response to receiving document data, cryptographically generating, by the first secure device, a first signature according to the first cryptographic scheme using the document data and the first private key, (c) cryptographically generating, by a second secure device, a second private key according to a second cryptographic scheme, (d) in response to receiving the document data and the first signature, generating composite data with a deterministic function based on the document data and supplemental data comprising at least one parameter uniquely associated with the first secure device, (e) cryptographically generating, by the second secure device, a second signature according to the second cryptographic scheme using the composite data and the second private key, (f) generating a total signature based on the first signature, the second signature, and the supplemental data; and (g) appending the total signature to the digital document from which the document data was derived.

### BRIEF DESCRIPTION OF THE DRAWINGS

Operation of the present disclosure may be better understood by reference to the following detailed description taken in connection with the following illustrations, wherein:

FIG. 1A illustrates a system that employs asymmetric cryptography using a single private key.

FIG. 1B illustrates a system that employs split-key asymmetric cryptography that uses multiple private key shares are that dependent on a single private key.

FIG. 2 illustrates a system that that employs universal composite key asymmetric cryptography that uses multiple data components, according to the teachings of the disclosure.

FIG. 3 is a conceptual diagram of a supplemental data generation function used by the system of FIG. 2, according to the teachings of the disclosure.

FIG. 4 is another conceptual diagram of a supplemental data generation function used by the system of FIG. 2, according to the teachings of the disclosure.

FIGS. 5 and 6 are a block diagram of electronic components of secure devices to perform the universal composite key asymmetric cryptography, according to the teachings of the disclosure.

FIGS. 7 and 8 illustrate example methods of using universal composite key asymmetric cryptography to digitally sign documents, according to the teachings of the disclosure.

### DETAILED DESCRIPTION

Reference will now be made in detail to exemplary embodiments of the present disclosure, examples of which are illustrated in the accompanying drawings. It is to be understood that other embodiments may be utilized, and structural and functional changes may be made without departing from the respective scope of the present disclosure. Moreover, features of the various embodiments may be combined or altered without departing from the scope of the present disclosure. As such, the following description is presented by way of illustration only and should not limit in any way the various alternatives and modifications that may be made to the illustrated embodiments and still be within the spirit and scope of the present disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

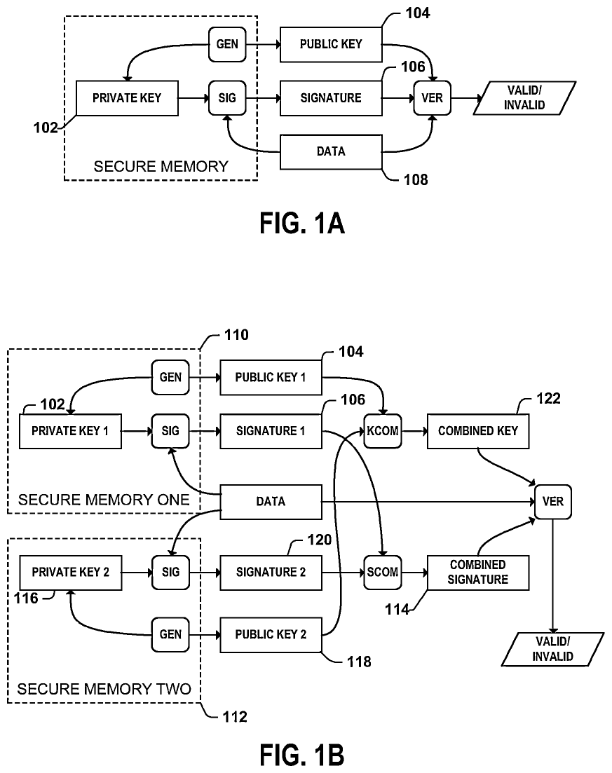

A common asymmetric cryptography scheme for creating digital signatures is the Rivest-Shamir-Adleman (RSA) algorithm. While different asymmetric algorithms may be used for single key cryptography, an example using the RSA algorithm is discussed below. As illustrated in FIG. 1A, the RSA algorithm uses a first generation function (GEN) to generate a private key 102 using two distinct prime numbers p and q. The prime numbers, p and q, are chosen at random, are generally of a similar magnitude, have a different length, and are kept secret. The RSA algorithm also uses a second generation function to generate a public key 104 based on the two prime numbers p and q (these functions are collectively notated as “GEN” in FIG. 1). The public key 104 includes a publicly known modulus (n) that is a function of p and q, and a publicly known exponent (e). The private key 102 consists of a secret exponent (d) that is a function of modulus (n) and exponent (e). Generally, after the private key 102 and the public key is generated, p and q are discarded along with any other intermediate calculations.

The RSA algorithm uses a signature function (SIG) create a signature 106 using data 108 with the private key 102. The data 108 is generally either (a) all or a part of a digital document to be signed or (b) a message digest computed from the digital document by applying a cryptographic hash function (e.g., SHA-256, etc.) to the digital document (DATA). In any case, the data 108 can be derived from the digital document such a system that is to determine the validity of a signature appended to the digital document can also derive the data 108. To authenticate a received signature 106 and an accompanying digital document, the RSA cryptosystem uses a fourth function (VER) based on the public modulus (n) and the public exponent (e).

For security reasons, cryptographically secure storage is used to protect the private key 102 and the operations with the private key 102, such as key generation and signing. Using special hardware devices (e.g., jewelry with embedded chips (e.g., bracelets, rings, broaches, etc.), or smart cards (e.g., a chip-embedded credit card, a chip-embedded identification card, etc.), etc.) as secure storage provides high security. However, secure storage is expensive to wide scale use and does not enable fast and proactive reactions in cases where the cryptographic algorithms or their implementations become insecure. For example, an implementation of the RSA algorithm may be flawed (e.g., easily guessed p and q values, etc.) and/or the length of the private key 102 may become insufficient in the face of a continuously improving computer computational power that can be harnessed to crack the private key 102 (e.g., determine p and q by brute force). These issues can hinder widespread use and adoption. While the proceeding describes the specifics of a cryptosystem using the RSA cryptography scheme, other single key public/private key cryptography schemes (e.g., Digital Signature Algorithm (DSA), Elliptic Curve Digital Signature Algorithm (ECDSA), Edwards-curve Digital Signature Algorithm (EdDSA), etc.) work similarly, though the equations/underlying algorithm might be different for each. Some of these other cryptographic schemes might be faster or more secure, but they suffer from similar limitations when using a secure device-based system.

One alternative to single key cryptography is combined key cryptography as illustrated in FIG. 1B. In the illustrated example, two secure devices 110 and 112 cooperate to generate a combined signature 114 to attach to the digital document. The two secure devices 112 and 110 each generate a private key 102 and 116 using the generation function (GEN) (as described above). Sometimes, the secure devices 112 and 110 might simply store a private key share generated by a third device. Sometimes, the secure devices 110 and 112 also each generate a public key 104 and 118 with a public modulus (n) and a public exponent (e) (e.g., as described above). Other times, the third device might generate the public key for both secure device 110 and 112. The public keys 104 and 118 are transmitted to a remote computing device stored in a public key database associated with the corresponding security device. When the secure devices 110 and 112 receive the data (DATA) to use to generate a combined signature, the secure devices 110 and 112 use the signature function (SIG) (as described above) to each generate a signature 106 and 120. To sign a digital document, the combined signature 114 is generated from the first signature 106 and the second signature according to a signature combination function (SCOM). The combined signature 114 is appended to the digital document.

To authenticate a received combined signature 114 and an accompanying digital document, the combined key cryptosystem generates combined public key 122 using key combination function (KCOM) using the public keys 104 and 118 of the secure devices 110 and 112 used to generate the combined signature 114. The cryptosystem uses the verify function (VER) to determine the authenticity of the combined signature 114. Often, these combined key public-private key crypto schemes are more secure.

Some schemes, such as RSA-based combined key crypto schemes may mathematically combine keys (e.g., additive combination or multiplicative combination, etc.) (sometimes referred to as “functional composition”). For these crypto schemes, generating the combination keys is relatively fast. Other crypto schemes, such as DSA, ECDSA and EdDSA, etc., use protocol composition. Protocol composition can be more computationally intensive and relatively inefficient. These combined key cryptosystems can have the same issues as the single key cryptosystems. Namely, the problems of distributing updates or changing crypto schemes can be impractical, especially for non-networked security devices with relatively low amounts of processing power. Additionally, the combined key cryptosystems also require that both secure devices 110 and 112 use the same type of crypto scheme. This means that when a weakness is discovered, both secure devices 110 and 112 need to be updated. Due to these factors, generally, RSA is used for combined key cryptosystems. However, if sufficiently efficient quantum computers emerge, for example, the RSA (and possibly the DSA and ECDSA) crypto scheme will become insecure to use. Additionally, post-quantum crypto schemes (e.g., crypto schemes that are quantum attack resistant) do not have known methods to be combined as shown in FIG. 1B.

Another shortcoming of these combination key cryptosystems wherein one of the secure devices is a server, the server must have separate private keys to exclusively use with each other secure device. If only one private key for the server is used to combine with the private key every other secure device to generate a combined signature, if the private key of one secure device (“client 1”) is accidentally disclosed to another client (client 2), it is possible for the client 2 to forge the combined signature to look as if a document was signed by client 1. This means that the server has to manage a large database of the secure devices' private keys. This is costly in terms of memory and introduces risks of securely storing and using these private keys.

As described herein below, the system to generate universal composition signatures provides improved efficiency of generating cryptographically secure signatures when, for example, one device cooperating in signature generation has relatively low processing power (e.g., a chip-embedded smart card, etc.) and cannot perform the calculations necessary to provide the latest crack-resistant signature generation. That is, the low processing power device may not be able to perform the calculations necessary in a timely manner, if at all. Additionally, even if the low processing power device were to be compromised, the system generating universal composition signatures as described below prevents cryptographic signatures generated using the low processing power device from being forged.

The system for generating universal composition signatures addresses a specific technical problem that existed in prior signature generation schemes, namely at least providing up-to-date cryptographically secure signatures when one device cooperating in the signature generation scheme cannot be updated and may not have the processing power to implement the updated cryptography. Cryptography is a technological arms race. This technical problem can be especially apparent as computers become more computationally powerful such that computational resources (e.g., calculations per second, etc.) necessary to break a cryptography scheme (i.e., sign a message without having access to the private key) become practically available. For example, Secure Hash Algorithm 1 (SHA-1) is obsolete because modern computing power can create identical signatures out of different documents (e.g., to forge the authenticity of the second document). To combat this, more computationally intense cryptographic schemes are developed that may not be practically implemented on the low processing power device. As described herein, the system for generating universal composition signatures facilitates low processing power devices cooperating to generate a secure signature that uses more computationally intense cryptographic schemes.

The system for generating universal composition signatures addresses at least another specific technical problem. Prior signature cooperative public key infrastructure (PKI) schemes require both devices each have a unique set of keys associated with each other. For example, a central node (e.g., a server) would be required to generate and store a public-private key pair for each secondary device with which it cooperates to generate a signature. This is to prevent a valid signature from being generated when the private key of a secondary device is compromised (e.g., stolen or cracked, etc.) without the corresponding private key of the central node. However, this also means that a large database of public-private key pairs needs to be maintained and frequently accessed (e.g., at least one database call per signature). This becomes computationally and network intensive as the cooperative PKI scheme is more widely adopted and interfaces with a large number of secondary devices. As described herein, the system to generate universal composition signatures facilitates the central node using a single public-private key pair while maintaining the forgery-resistant feature of prior systems. This overcomes the problem of greater network and computational burdens that come with cooperating with a large number of secondary devices.

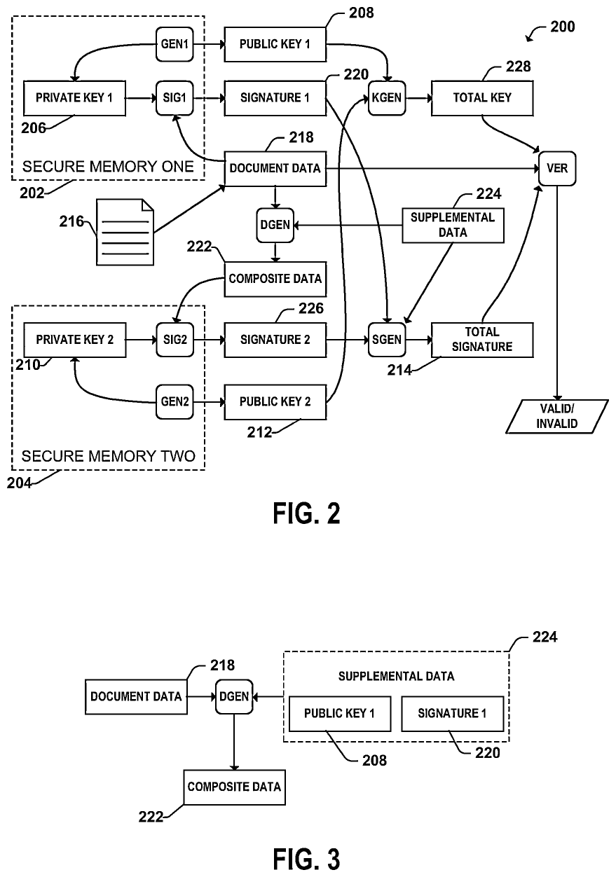

A universal composition method for digital signatures, as described herein in relation to FIGS. 2-8, can be applied to all crypto schemes, including post-quantum crypto schemes. In some examples, a secure device 202 operated by an end-user (sometimes referred to as a “client”) and secure device 204 operating on a server (sometimes referred to as the “server”) use two different crypto schemes. For example, the client 202 may use the RSA crypto scheme to generate a public key 206 and a private key 208, and the server 204 may use a post-quantum crypto scheme (e.g., SPHINCS-based cryptography, SPHINCS+-based cryptography, Nth degree truncated polynomial ring (NTRU) encryption, Random Linear Code encryption (RLCE), etc.) to generate a public key 210 and a private key 212. In some examples, the server 204 generates a public key 210 and a private key 212 for a group of multiple, unrelated clients 202. In some such examples, the server 204 only generates one public key 210 and one private key 212 for all of the clients 202.

FIG. 2 illustrates a system 200 that that employs universal composite key asymmetric cryptography that uses multiple data components. In the illustrated example, a first secure device 202 (e.g., a device with cryptographically secure memory and/or processing) and a second secure device 204 (e.g., a device with cryptographically secure memory and/or processing) cooperate to generate a total signature 214. The first secure device 202 may be incorporated into a special hardware device (e.g., jewelry with embedded chips, etc.) or a smart card (e.g., a chip-embedded credit card, a chip-embedded identification card, etc.), etc.) and is sometimes referred to as the “client.” The second secure device 204 may be incorporated into a remote device that manages the signature process and is sometimes referred to as the “server.”

In the illustrated example, the first secure device 202 includes a first generation function (GEN1) that used a first crypto scheme (e.g., RSA, DSA, ECDSA, EdDSA, etc.) to generate the private key 206 and the public key 208 for first secure device 202. The private key 206 is stored in the secure memory of the first secure device 202 and the public key is transmitted (e.g., to the server 204) to be stored in a database as associated with the first secure device 202 and/or an identifier associated with a user of the first secure device 202. After generating the private key 206 and the public key 208, the first secure device 202 may delete everything that was used to generate the private key 206 and the public key 208 (e.g., p and q, GEN1, etc.).

The second secure device 204 includes a second generation function (GEN2) that used a second crypto scheme (e.g., RSA, DSA, ECDSA, EdDSA, post-quantum, etc.) to generate the private key 210 and the public key 212 for second secure device 204. The second generation function (GEN2) may use a different crypto scheme compared to the first generation function (GEN1). In some examples, the second generation function (GEN2) generates the keys 210 and 212 independently from the first generation function (GEN1). Additionally, the generation of the keys 210 and 212 for the second secure device 204 may be asynchronous from the generation of the keys 206 and 208 for the first secure device 202. In such as manner, the first secure devices 202 may generate keys 206 and 206 as they are issued to users while the second secure device 202 may generate keys 210 and 212 as necessary to update the crypto scheme used by the second secure device 204. After generating the private key 210 and the public key 212, the second secure device 204 may delete everything that was used to generate the private key 210 and the public key 212 (e.g., p and q, GEN2, etc.). From time-to-time, the a new second generation function (GEN2) may be added to the second secure device 204 in order to generate new keys 210 and 212. For example, the new second generation function (GEN2) may be a more secure implementation of the crypto scheme or may be a newer, more up-to-date crypto scheme. In some examples, the second secure device 204 uses the new second generation function (GEN2) to regenerate the private key 210 and the public key 212.

When a digital document 216 is to be signed, the system 200 (e.g., via the server 204) generates document data 218 based on the digital document 216. The document data 218 may be all or a part of the digital document to be signed or a message digest computed from the digital document by applying a cryptographic hash function (e.g., SHA-256, etc.) to the digital document. The document data 218 originated from the first secure device 202, from the second secure device 204, or from any other source, such as a webpage, a desktop computer, a server, or a mobile device, etc. For example, when the first secure device 202 is a chip-embedded card and the second secure device 204 is a server operating as part of a Signature-as-a-Service platform, the document data 218 may be provided by the website or service using the Signature-as-a-Service platform (e.g., a commercial website, a government website, a legal document repository, etc.). The document data 218 may be sent to both secure devices 202 and 204 simultaneously. Alternative, in some examples, the document data 218 may initially be sent to the first secure device 202 that then forwards the document data 218 to the second secure device 204, or vice versa. Using its private key 206 and the document data 218, the first secure device 202 uses a first signature function (SIG1) to generate a first signature 220.

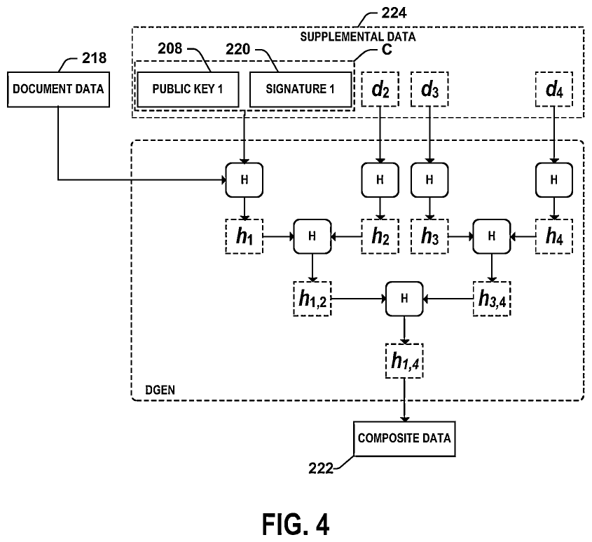

The system 200 (e.g., via the server 204) generates composite data 222 based on the document data 218 using a data generation function (DGEN). In the illustrated example, the data generation function combines the document data 218 with supplemental data 224. The data generation function may be any function that reliably and repeatably combines two sets of data. Example data generation functions are described in connection with FIGS. 3 and 4 below. The supplemental data 224 includes at least one parameter is unique and specific to the first secure device 202. Using its private key 210 and the composite data 222, the second secure device 204 uses a second signature function (SIG2) to generate a second signature 220. The system 200 (e.g., via the server 204) uses a universal composition function (SGEN) to combine the first and second signatures 220 and 226 into the total signature 214. The universal composition function (SGEN) may be any deterministic or probabilistic function of the first and the second digital signatures 220 and 226 and the supplemental data 224, such that it is possible, based on the result (output) of SGEN to completely reconstruct the second and the first digital signatures 220 and 226. In some examples, the result of applying SGEN (the total signature 214) is concatenation of the first and second digital signature 220 and 226. In some examples, the result of applying SGEN (the total signature 214) is obtained by applying an invertible linear transformation to the pair of the first and the second digital signatures 220 and 226, where the pair of the first and the second digital signatures 220 is taken as a vector (e.g., an element of a vector space or, more generally, any Z-module). In some examples, the result of applying SGEN (the total signature 214) is obtained by the concatenation of the first and the second digital signatures 220 and 226 and any (deterministic or probabilistic) function of the supplemental data, where the function may, for example, be the identity function (e.g., the total signature contains a triple of the first and the second digital signature 220, 226, and the supplemental data 224). In some examples, the result of SGEN (the total signature 214), in addition to using the first and the second digital signatures, also contain a set of cryptographic hashes computed by a cryptographic hash function. For example, similar to the supplemental data generation function (DGEN) as illustrated in FIG. 4 below, the set of hash functions may contain the sibling hashes h₂ and h_{3,4} of the unique path from the leaf containing the first public key 208 and the first digital signature 220 to the root hash h_{1,4} of the Merkle tree. The total signature 214 is then attached to the document 216.

When the total signature 214 is then attached to the document 216 is to be verified, the system 200 (e.g., via the server 204) uses a universal key function (KGEN) to combine the first and second public keys 208 and 212 into a total key 228. The system 200 (e.g., via the server 204) then uses the verification function (VER) with the total key 228 and the document data 218 218 to determine if the total signature 214 is valid. Even if the private key of the signing client is accidentally disclosed to a different client or a malicious actor, it would not be possible for that second client to forge the signing client's total signature because the server's signature depends on client-specific parameters included into supplemental data 224. Attempts to recombine the server's signature 226 based on the second client with the forged signature 220 of the signing client via the universal composition function (SGEN) results in an invalid total signature 214.

FIG. 3 is a conceptual diagram of a supplemental data generation function (DGEN) used by the system 200 of FIG. 2. The supplemental data 224 includes at least one parameter is unique and specific to the first secure device 202. In the illustrated example of FIG. 3, the supplemental data 224 includes the public key 208 of the first secure device 202 and the first signature 220 that was generated based on the document data 218. The supplemental data generation function (DGEN) is any deterministic function that combines the document data 218 and the supplemental data 224, such as a concatenation function or a cryptographic hash function. The resulting composite data 222 is unique value generated from the parameters unique and specific to the first secure device 202.

FIG. 4 is an example of a supplemental data generation function (DGEN) used by the system 200 of FIG. 2 In the illustrated example, supplemental data generation function (DGEN) is computed as the root hash of a Merkle tree with leaves C, d2, d3, . . . , dm, where C is a combination of the public key 208 of the first secure device 202 and the first signature 220 that was generated based on the document data 218 and d2, d3, . . . , dm is a sequence of data items (e.g., other parameters related to the server 204, the user, etc.). The authentication path of the Merkle tree consists of the sibling hashes of the unique path from the leaf containing C and the document data 218 to the root hash of the tree.

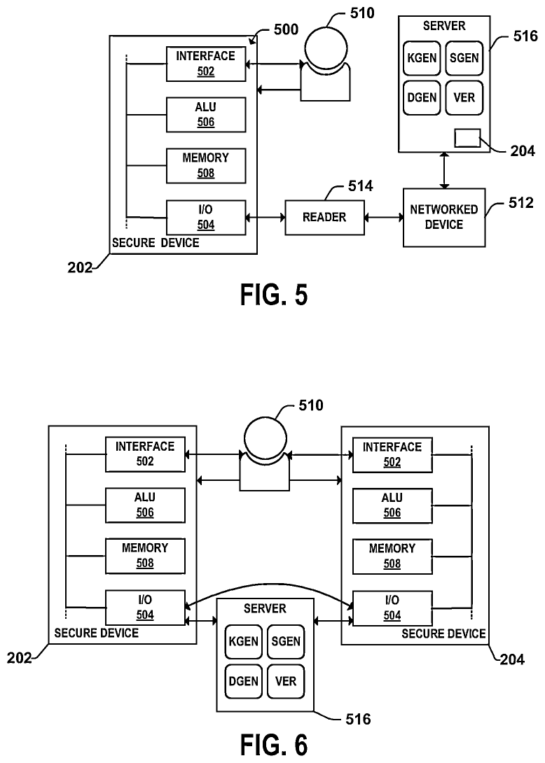

FIG. 5 is a block diagram of electronic components 500 of secure device 202 to perform the universal composite key asymmetric cryptography. The electronic components 500 includes the hardware and software to implement the secure device 202. In illustrated example, the electronic components 500 include a user interface 502, an I/O interface 504, a processor or controller 506, and memory 508, connected together via a data bus. A secure device 202 may have more or fewer of these features.

The user interface 502 provides an interface between the security device 202 and a signer 510. The control interface 502 may include an audio and/or visual sensors (e.g., for image capture, visual command recognition, facial recognition, iris recognition, voice recognition etc.), a touch screen and/or keyboard (e.g., for input of credentials), a biometric sensor (e.g., a fingerprint scanner, a pulse oximeter, a pulse sensor, etc.). The control interface 502 receives input from the signer 510 to authenticate the signer 510. In some examples, the control interface 502 may include multiple component to aid identifying and authenticating the signer 510. For example, the signer 510 may need to provide a fingerprint and a password. As another example, the control interface 502 may include a fingerprint scanner and a pulse oximeter to authenticate identity and status of the signer 510.

The I/O interface 504 is an interface to communicate directly or indirectly with other devices (e.g., server 204) to cooperate in the universal composite asymmetric key system as described herein. The I/O interface 504 may include, for example, communication controllers and antenna for one or more for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); Near Field Communication (NFC); local area wireless network (including IEEE 802.11 a/b/g/n/ac or others), Bluetooth® and Bluetooth® Low Energy, and Wireless Gigabit (IEEE 802.11ad), etc.). In some examples, the I/O interface 504 may be a chip interface that communicates with a networked device 512 via a chip reader 514 to securely exchange data (e.g., the document data 218, the first signature 220, etc.) between the first secure device 202 and the second secure device 204. In some examples, the I/O interface 504 may also be a power interface that provides power to the secure device 202 while plugged into the chip reader 514. In some examples, the I/O interface 504 may include multiple communication options to provide redundant communication paths to the second secure device 204.

The processor or controller 506 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 508 may be volatile memory, non-volatile memory, unalterable memory, read-only memory, and/or high-capacity storage devices (e.g., hard drives, solid state drives, etc.). In some examples, the memory 404 includes multiple kinds of memory, particularly volatile memory and non-volatile memory. Additionally, the memory 508 may include secure memory (sometimes referred to as “cryptomemory”) which includes an embedded hardware encryption engine with its own authentication keys to securely store information.

The signer 510 uses the user interface 502 to enter credentials used to allow access to the private key 206 and the first signature function (SIG1). For example, the first secure device 202 may prevent access to the private key 206 and the first signature function (SIG1) until a PIN is input into the user interface 502. The memory 508 may store the credentials necessary to provide access to the private key 206 and the first signature function (SIG1). For example, the memory 508 may store a password and/or PIN used to verify the identity of the signer 510.

In the illustrated example of FIG. 5, a server 516 implements the second secure device 204. The example server 516 includes the universal composition function (SGEN), the total public key function (KGEN), the supplemental data generation function (DGEN), and the verification function (VER). The server 516 may include a public key database that associates each public key 208 to a particular first secure device 202 and, in some examples, to a particular signer 510. In some examples, the server 516 includes an authentication database used to authenticate the signer 510 before providing access to, for example, universal composition function (SGEN), the total public key function (KGEN), the supplemental data generation function (DGEN), and/or the verification function (VER). This authentication may be separate than any authentication that is performed by the first secure device 202.

FIG. 6 illustrated another example configuration of the secure devices 202 and 204 relative to each other. In the illustrated example, the secure devices 202 and 204 each have the user interface 502, the I/O interface 504, the processor or controller 506, and the memory 508. The secure devices 202 and 204 may be different types of devices with differing capabilities. For example, the processor 506 for the second secure device 204 may have a greater computational capacity than the processor 506 of the first secure device 202. Additionally, the secure devices 202 and 204 may have different abilities to be updated and/or communicated with. For example, the first secure device 202 may be a chip-embedded card and the second secure device 202 may be a smart device (e.g., a smartphone, a smart watch, a tablet, etc.). When performing the signature process, the secure devices 202 and 204 are communicatively coupled to the server 516 and directly or indirectly to each other. In the illustrated example, the server 516 includes the universal composition function (SGEN), the total public key function (KGEN), the supplemental data generation function (DGEN), and the verification function (VER). Alternatively, in some examples, the second secure device 204 may include one or more of these functions. For example, the second secure device 204 may include the supplemental data generation function (DGEN).

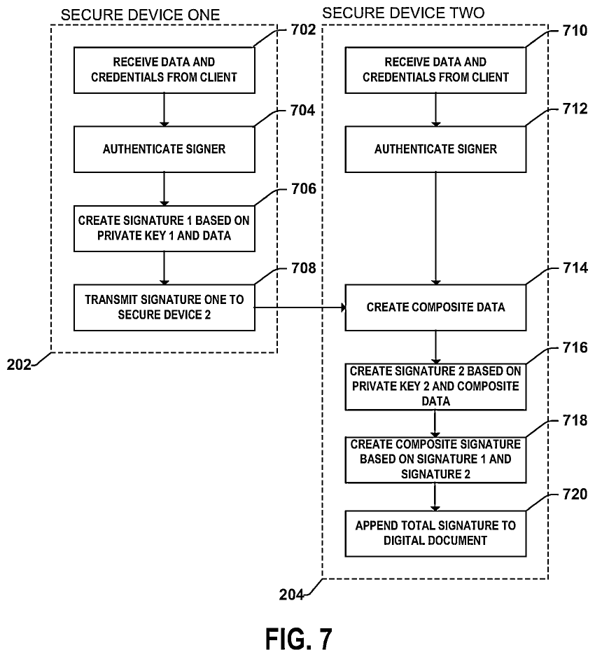

FIG. 7 illustrates an example method of using universal composite key asymmetric cryptography to digitally sign documents. While FIG. 7 illustrates steps that may be taken synchronously, the steps may also be asynchronous. The first secure device 202 is configured to cooperate with the second secure device 204 when a signature is requested. Initially, the first secure device 202 receives the document data 218 and credentials from the user 510 (e.g., via the user interface 502) (block 702). The credentials are used to verify the identity of the signer 510 before access to the private key 206 is provided. For example, the credentials may be a username and password, a PIN, and/or a biometric marker, etc. Based on the credentials, the first secure device 202 authenticates the signer 510 (block 704). The first secure device 202 uses the first signature function (SIG1) and the private key 206 to generate the first signature 220 using the document data 218 (block 706). The first secure device 202 causes, directly or indirectly, the first signature 220 to be transmitted to the second secure device 204 (block 708).

The second secure device 204 receives the document data 218 and credentials from the user 510 (block 710). The credentials are used to verify the identity of the signer 510 before access to the private key 210 is provided and may be different than the credentials used to authenticate through the first secure device 204. The second secure device 204 authenticates the signer 510 (block 712). After verifying the singer 510 and receiving the first signature 220, the second secure device 204 creates the composite data 222 using the supplemental data generation function (DGEN) based on at least one unique parameter of the first secure device 202 and/or the signer 510 (e.g., the public key 208 associated with the first secure device 202/the signer 510, the first signature 220, identification number associated with the signer 510, etc.) (block 714). The second secure device 204 creates the second signature 226 with the private key 210 using the second signature function (SIG2) based on the composite data 222 (block 716). The second secure device 204 creates the total signature 214 using the universal composition function (SGEN) based on the first signature 220 and the second signature 226 (block 718). The second secure device 204 appends the total signature 214 to the document 216 (block 720).

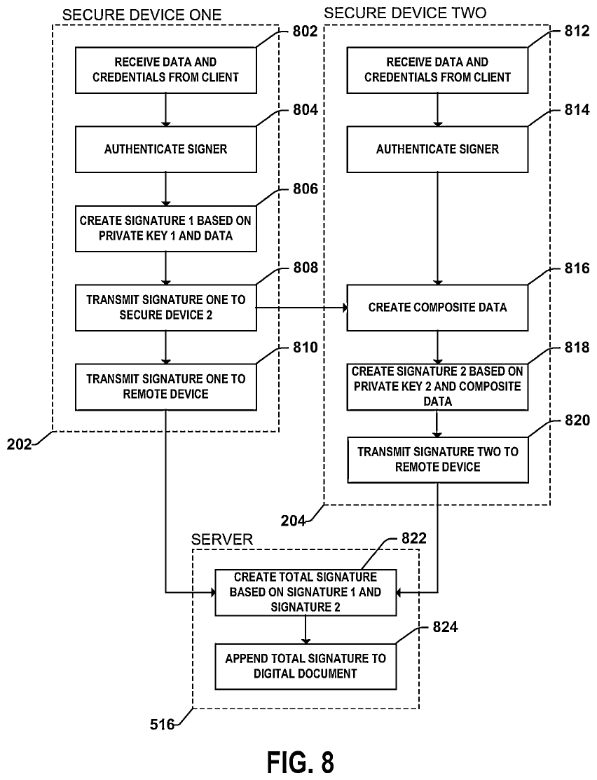

FIG. 8 illustrates an example method of using universal composite key asymmetric cryptography to digitally sign documents with two secure devices 202 and 204 and a server 516. While FIG. 8 illustrates steps that may be taken synchronously, the steps may also be asynchronous. The first secure device 202 is configured to cooperate with the second secure device 204 and the server 516 when a signature is requested. Initially, the first secure device 202 receives the document data 218 and credentials from the user 510 (e.g., via the user interface 502) (block 802). The credentials are used to verify the identity of the signer 510 before access to the private key 206 is provided. For example, the credentials may be a username and password, a PIN, and/or a biometric marker, etc. Based on the credentials, the first secure device 202 authenticates the signer 510 (block 804). The first secure device 202 uses the first signature function (SIG1) and the private key 206 to generate the first signature 220 using the document data 218 (block 806). The first secure device 202 causes, directly or indirectly, the first signature 220 to be transmitted to the second secure device 204 (block 808). The first secure device 202 also causes, directly or indirectly, the first signature 220 to be transmitted to the server 516 (block 810).

The second secure device 204 receives the document data 218 and credentials from the user 510 (e.g., via the user interface 502, etc.) (block 812). The credentials are used to verify the identity of the signer 510 before access to the private key 210 is provided and may be different than the credentials used to authenticate through the first secure device 204. The second secure device 204 authenticates the signer 510 (block 814). After verifying the singer 510 and receiving the first signature 220, the second secure device 204 creates the composite data 222 using the supplemental data generation function (DGEN) based on at least one unique parameter of the first secure device 202 and/or the signer 510 (e.g., the public key 208 associated with the first secure device 202/the signer 510, the first signature 220, identification number associated with the signer 510, etc.) (block 816). The second secure device 204 creates the second signature 226 with the private key 210 using the second signature function (SIG2) based on the composite data 222 (block 818). The second secure device 204 causes, directly or indirectly, the second signature 226 to be transmitted to the server 516 (block 820).

The server 516 creates the total signature 214 using the universal composition function (SGEN) based on the first signature 220 and the second signature 226 (block 822). The server 516 appends the total signature 214 to the document 216 (block 824).

Although the embodiments of the present invention have been illustrated in the accompanying drawings and described in the foregoing detailed description, it is to be understood that the present disclosure is not to be limited to just the embodiments disclosed, but that the disclosure described herein is capable of numerous rearrangements, modifications and substitutions without departing from the scope of the claims hereafter. The terms “includes,” “including,” and “include” are inclusive and have the same scope as “comprises,” “comprising,” and “comprise” respectively. The claims as follows are intended to include all modifications and alterations insofar as they come within the scope of the claims or the equivalent thereof.

Having thus described the invention, the following is claimed:

1. A system for generating a digital signature comprising
a first secure device configured to:
generate a first private key according to a first cryptographic scheme, and
in response to receiving document data, cryptographically generate a first signature according to the first cryptographic scheme using the document data and the first private key; and
a second secure device configured to:
cryptographically generate a second private key according to a second cryptographic scheme, and
in response to receiving the document data and the first signature, generate composite data with a deterministic function based on the document data and supplemental data comprising at least one parameter uniquely associated with the first secure device,
cryptographically generate a second signature according to the second cryptographic scheme using the composite data and the second private key,
generate a total signature based on the first signature, the second signature, and the supplemental data, and
append the total signature to a digital document from which the document data was derived.

2. The system of claim 1, wherein the first cryptographic scheme is a different cryptographic scheme than the second cryptographic scheme.

3. The system of claim 1, wherein the deterministic function is a hash function that hashes together the document data and the supplemental data.

4. The system of claim 1, wherein the deterministic function is a Merkle tree and wherein the composite data is a root hash of the Merkle tree with the document data and the supplemental data as leaves.

5. The system of claim 1, wherein the parameter uniquely associated with the first secure device includes the first signature.

6. The system of claim 1, wherein the supplemental data comprises the first signature and a public key corresponding to the first private key.

7. The system of claim 1, wherein the first cryptographic scheme is selected from a group of Rivest-Shamir-Adleman (RSA) cryptography, Digital Signature Algorithm (DSA) cryptography, Elliptic Curve Digital Signature Algorithm (ECDSA) cryptography, Edwards-curve Digital Signature Algorithm (EdDSA) cryptography, and wherein the second cryptographic scheme is a post-quantum cryptographic scheme.

8. The system of claim 1, wherein the first secure device is integrated in a chip-embedded card and the second secure device is integrated in a server.

9. A system for generating a digital signature comprising
a first secure device configured to:
generate a first private key according to a first cryptographic scheme, and
in response to receiving document data, cryptographically generate a first signature according to the first cryptographic scheme using the document data and the first private key;
a second secure device configured to:
cryptographically generate a second private key according to a second cryptographic scheme, and
in response to receiving the document data and the first signature, generate composite data with a deterministic function based on the document data and supplemental data comprising at least one parameter uniquely associated with the first secure device,
cryptographically generate a second signature according to the second cryptographic scheme using the composite data and the second private key; and
a server configured to:
generate a total signature based on the first signature, the second signature, and the supplemental data, and
append the total signature to a digital document from which the document data was derived.

10. The system of claim 9, wherein the first cryptographic scheme is a different cryptographic scheme than the second cryptographic scheme.

11. The system of claim 9, wherein the deterministic function is a hash function that hashes together the document data and the supplemental data.

12. The system of claim 9, wherein the deterministic function is a Merkle tree and wherein the composite data is a root hash of the Merkle tree with the document data and the supplemental data as leaves.

13. The system of claim 9, wherein the parameter uniquely associated with the first secure device includes the first signature.

14. The system of claim 9, wherein the supplemental data comprises the first signature and a public key corresponding to the first private key.

15. The system of claim 9, wherein the first cryptographic scheme is selected from a group of Rivest-Shamir-Adleman (RSA) cryptography, Digital Signature Algorithm (DSA) cryptography, Elliptic Curve Digital Signature Algorithm (ECDSA) cryptography, Edwards-curve Digital Signature Algorithm (EdDSA) cryptography, and wherein the second cryptographic scheme is a post-quantum cryptographic scheme.

16. The system of claim 9, wherein the first secure device is integrated in a chip-embedded card and the second secure device is integrated in a smartphone.

17. A method to generate a signature for a digital document comprising:
generating, by a first secure device, a first private key according to a first cryptographic scheme;
in response to receiving document data, cryptographically generating, by the first secure device, a first signature according to the first cryptographic scheme using the document data and the first private key;
cryptographically generating, by a second secure device, a second private key according to a second cryptographic scheme;
in response to receiving the document data and the first signature, generating composite data with a deterministic function based on the document data and supplemental data comprising at least one parameter uniquely associated with the first secure device;
cryptographically generating, by the second secure device, a second signature according to the second cryptographic scheme using the composite data and the second private key;
generating a total signature based on the first signature, the second signature, and the supplemental data; and
appending the total signature to the digital document from which the document data was derived.

18. The method of claim 17, wherein the first cryptographic scheme is a different cryptographic scheme than the second cryptographic scheme.

19. The method of claim 17, wherein the deterministic function is a Merkle tree and wherein the composite data is a root hash of the Merkle tree with the document data and the supplemental data as leaves.

20. The method of claim 17, wherein the supplemental data comprises the first signature and a public key corresponding to the first private key.
